(19) United States
(12) Patent Application Publication
(10) Pub. No.: US 2022/0122359 A1
(43) Pub. Date: Apr. 21, 2022

(54) IMAGE PROCESSING METHOD, APPARATUS, AND STORAGE MEDIUM

(71) Applicant: SENSETIME INTERNATIONAL PTE. LTD., Singapore (SG)

(72) Inventors: Wenbin ZHANG, Singapore (SG); Yao ZHANG, Singapore (SG); Shuai ZHANG, Singapore (SG); Shuai YI, Singapore (SG)

(21) Appl. No.: 17/562,207

(22) Filed: Dec. 27, 2021

Related U.S. Application Data
(63) Continuation of application No. PCT/IB2021/062078, filed on Dec. 21, 2021.

(30) Foreign Application Priority Data
Dec. 9, 2021 (SG) 10202113657P

(51) Int. Cl. G06V 20/50; G06T 7/20; G06V 40/10; G06V 40/16

(52) U.S. Cl. CPC G06V 20/50; G06V 40/16; G06V 40/107; G06T 7/20

(57) ABSTRACT

An image processing method and apparatus, an electronic device and a storage medium are provided. In the method, scene images corresponding to a game area at different viewpoints during a gaming stage are acquired to obtain a plurality of groups of scene images, and each group of scene images in the plurality of groups of scene images includes at least one frame of scene image corresponding to the game area at the same viewpoint; object analysis is performed on the plurality of groups of scene images to obtain object analysis data corresponding to the game area; and the object analysis data is written into an object general-purpose data structure, and the object general-purpose data structure is provided with positions for supporting storage of various types of data related to the object analysis data.

### CROSS-REFERENCE TO RELATED APPLICATIONS

This application is a continuation application of International Patent Application No. PCT/IB2021/062078, filed on Dec. 21, 2021, which is based on and claims priority from Singapore Patent Application No. 10202113657P, filed on Dec. 9, 2021. The disclosures of International Patent Application No. PCT/IB2021/062078 and Singapore Patent Application No. 10202113657P are incorporated herein by reference in their entireties.

### TECHNICAL FIELD

The present disclosure relates to the field of computer vision technology, and in particular, to an image processing method, apparatus, and storage medium.

### BACKGROUND

In some specific activity scenes such as game scenes, a plurality of cameras are commonly deployed around a game area to realize the collection of scene images from the game area at different viewpoints.

At present, an electronic device may perform related processing such as detection, recognition, and tracking of scene images, and the obtained data is huge and various in types. The conventional text-based format is used to record a large amount of data one by one, which not only occupies a large amount of memory and takes a long time.

### SUMMARY

The embodiments of the present disclosure expect to provide an image processing method, apparatus, and storage medium.

The technical solutions in the embodiments of the present disclosure are implemented as follows.

The embodiments of the present disclosure provide an image processing method, the method includes the following steps: scene images corresponding to a game area at different viewpoints during a gaming stage are acquired to obtain a plurality of groups of scene images, and each group of scene images in the plurality of groups of scene images includes at least one frame of scene image corresponding to the game area at the same viewpoint; object analysis is performed on the plurality of groups of scene images to obtain object analysis data corresponding to the game area; the object analysis data is written into an object general-purpose data structure, and the object general-purpose data structure is provided with positions for supporting storage of various types of data related to the object analysis data.

The embodiments of the present disclosure provide an image processing apparatus which include a memory for storing instructions; and a processor configured to execute the instructions to: acquire scene images corresponding to a game area at different viewpoints during a gaming stage to obtain a plurality of groups of scene images, wherein each group of scene images in the plurality of groups of scene images comprises at least one frame of scene image corresponding to the game area at a same viewpoint; perform object analysis on the plurality of groups of scene images to obtain object analysis data corresponding to the game area; and write the object analysis data into an object general-purpose data structure, wherein the object general-purpose data structure is provided with positions for supporting storage of various types of data related to the object analysis data.

The embodiments of the present disclosure provide a computer-readable storage medium having stored thereon one or more programs that when executed by one or more processors to implement an image processing method, the method including:

acquiring scene images corresponding to a game area at different viewpoints during a gaming stage to obtain a plurality of groups of scene images; wherein each group of scene images in the plurality of groups of scene images comprises at least one frame of scene image corresponding to the game area at a same viewpoint; performing object analysis on the plurality of groups of scene images to obtain object analysis data corresponding to the game area; and writing the object analysis data into an object general-purpose data structure, wherein the object general-purpose data structure is provided with positions for supporting storage of various types of data related to the object analysis data.

### BRIEF DESCRIPTION OF THE DRAWINGS

FIG. 1 illustrates a first schematic flowchart of an image processing method according to an embodiment of the present disclosure.

FIG. 2 illustrates a schematic diagram of an exemplary thread scheduling according to an embodiment of the present disclosure.

FIG. 3 illustrates a schematic diagram of an exemplary object general-purpose data structure according to an embodiment of the present disclosure.

FIG. 4 illustrates a schematic diagram of an image processing apparatus according to an embodiment of the present disclosure.

FIG. 5 illustrates a schematic diagram of an electronic device according to an embodiment of the present disclosure.

### DETAILED DESCRIPTION

In order to make the objectives, technical solutions, and advantages in the embodiments of the present disclosure clearer, the technical solutions in the embodiments of the present disclosure will be described clearly and completely with reference to the accompanying drawings in the embodiments of the present disclosure. It is apparent that the described embodiments are not all of the embodiments, but only a part of the embodiments of the present disclosure. The following embodiments are used to illustrate the present disclosure, but are not used to limit the scope of the present disclosure. According to the embodiments of the present disclosure, all other embodiments obtained by those of ordinary skill in the art without creative effort shall fall within the protection scope of the present disclosure.

In the following description, “some embodiments” are referred to, which describe a subset of all possible embodiments, but it may be understood that “some embodiments” may be the same subset or different subsets of all possible embodiments, and may be combined with each other without conflict.

It is to be pointed out that the term “first/second/third” involved in the embodiments of the present disclosure only distinguishes similar objects, and does not represent a specific order of objects. Understandably, “first/second/third”, if permitted, the preset sequence or order may be interchanged, so that the embodiments of the present disclosure described herein may be implemented in a sequence other than those illustrated or described herein.

The embodiments of the present disclosure provide an image processing method whose execution subject may be an image processing apparatus. For example, the image processing method may be executed by a terminal device or a server or other electronic device. The terminal device may be a user equipment (UE), a mobile device, a user terminal, a cellular phone, a cordless phone, a personal digital assistant (PDA), a handheld device, a computing device, an in-vehicle device, a wearable device, etc. In some possible implementations, the image processing method may be implemented by invoking computer-readable instructions stored in the memory by a processor.

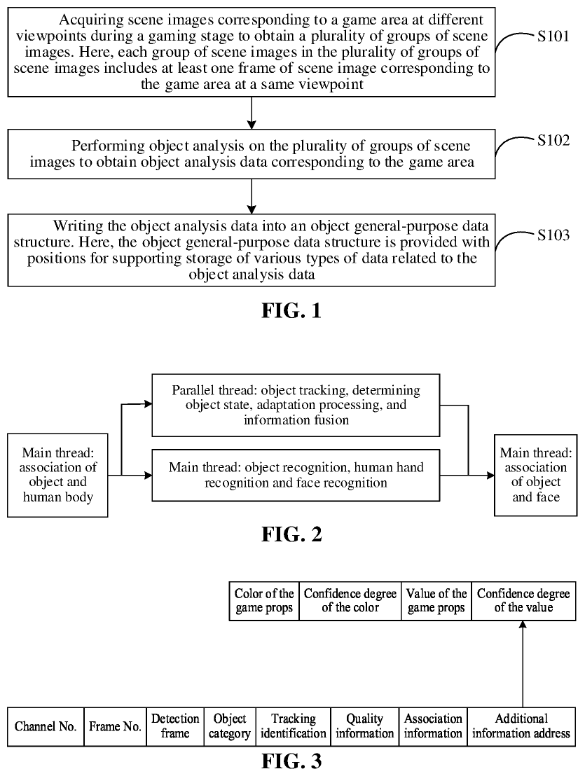

The embodiments of the present disclosure provide an image processing method. FIG. 1 illustrates a first schematic flowchart of an image processing method according to an embodiment of the present disclosure. As illustrated in FIG. 1, in the embodiments of the present disclosure, the method mainly includes the following steps:

In S101, scene images corresponding to a game area at different viewpoints during a gaming stage are acquired to obtain a plurality of groups of scene images, and each group of scene images in the plurality of groups of scene images includes at least one frame of scene image corresponding to the game area at the same viewpoint.

In the embodiments of the present disclosure, the image processing apparatus may acquire images corresponding to the game area at different viewpoints during a gaming stage to obtain a plurality of groups of scene images.

It is to be noted that, in the embodiments of the present disclosure, the image processing apparatus may detect various stages of the game, so that the image processing apparatus may detect various stages of the game in the case of the game stage.

It is to be noted that, in the embodiments of the present disclosure, in the board game scene, the game area during a gaming stage may be a game table. For different types of games, the game area during a gaming stage may be different specific areas, which will not be limited by the embodiments of the present disclosure.

It is to be noted that, in the embodiments of the present disclosure, the image processing apparatus may include a plurality of camera modules, and the plurality of camera modules are deployed in the game area, such as a game table, in a plurality of different positions around the periphery, and the scene image corresponding to the game area at a viewpoint may be collected in each camera module, and a plurality of groups of scene images may be collected by a plurality of camera modules. In addition, the plurality of groups of scene images may also be collected by a plurality of independent cameras deployed in different directions around the game area, and each camera collects a group of scene images. The specific method for acquiring a plurality of groups of scene images will not limited in the embodiments of the present disclosure.

It is to be noted that, in the embodiments of the present disclosure, the image processing apparatus may automatically associate scene images corresponding to different viewpoints with different identifiers to distinguish the viewpoint corresponding to each group of scene images in the plurality of groups of collected scene images, for example, the image processing apparatus acquires three groups of scene images corresponding to the three viewpoints of the game area during a gaming stage, and may specify a corresponding view number with respect to each group of scene images to distinguish the viewpoints. In addition, the image processing apparatus may also associate a plurality of groups of scene images with the same frame number at the same time. For example, the image processing apparatus acquires three groups of scene images corresponding to the game area at three viewpoints during a gaming stage, and may group the same frame number for three frames of scene images with different viewpoints at the same time in three groups of scene images, so as to be the judgment standard of scene images with three viewpoints at the same time.

It is to be noted that, in the embodiments of the present disclosure, the viewpoint at which the image processing apparatus acquires the scene image of the game area during a gaming stage may be set according to actual needs, which will not be limited in the embodiments of the present disclosure.

In S102, object analysis is performed on the plurality of groups of scene images to obtain object analysis data corresponding to the game area.

In the embodiment of the present disclosure, in the case of obtaining a plurality of groups of scene images, the image processing apparatus may perform object analysis on the plurality of groups of scene images, so as to obtain object analysis data corresponding to the game area.

Specifically, in the embodiments of the present disclosure, in the image processing apparatus, the performing object analysis on the plurality of groups of scene images to obtain object analysis data corresponding to the game area includes the following steps: a main thread is invoked to perform object detection on the plurality of groups of scene images and the association between an object and a human body to obtain first association data; a parallel thread is invoked to perform a first object analysis processing on the plurality of groups of scene images to obtain first processing data, and the main thread is invoked at the same time to perform a second object analysis processing on the plurality of groups of scene images to obtain second processing data, and the first object analysis processing and the second object analysis processing are not related in time sequence; the main thread is invoked, and an object is associated with a face for the plurality of groups of scene images according to the first association data, the first processing data, and the second processing data to obtain second association data; and the first association data, the second association data, the first processing data, and the second processing data are determined as the object analysis data.

It is to be noted that, in the embodiments of the present disclosure, a main thread and a parallel thread are deployed in the image processing apparatus. In the case of acquiring a plurality of groups of scene images in the image processing apparatus, the main thread may be firstly invoked to perform object detection on each group of scene images in the plurality of groups of scene images, that is, the objects included in each frame of scene image in each group of scene image are detected, and the object is associated with the human body to obtain first association data, thereafter considering that the intensive CPU processing such as object tracking is not related to the intensive GPU processing such as object recognition in time sequence, and therefore, it is possible to invoke the main thread at the same time to perform the second object analysis processing of a plurality of groups of scene images, that is, GPU-intensive processing, while invoking the parallel thread to perform the first object analysis processing of a plurality of groups of scene images, that is, CPU-intensive processing, thereby improving the image processing speed. In addition, since the association between the object and the humane face in the scene image requires the combination of the first association data, and the first processing data and the second processing data obtained by parallel processing, and therefore, in the image processing apparatus, in the case where the first processing data and the second processing data are obtained, the main thread is then invoked to associate the objects and faces in the plurality of groups of scene images in combination with the above data to obtain the second association data. In the image processing apparatus, in combination with the first association data, the first processing data, and the second processing data, objects and faces in the plurality of groups of scene images are associated with each other, the data used to support the determination of the association relationship between the objects and the faces may be selected from the data, and then the association is performed, and the specific data applied will not be limited in the embodiments of the present disclosure.

It is to be noted that, in the embodiments of the present disclosure, the first object analysis processing includes: object tracking, determining object state, adaptation processing, and information fusion.

It is to be noted that in the embodiments of the present disclosure, the first object analysis processing mainly involves some logical operations of image data, and the specific processing methods involved in the above first object analysis processing are only optional methods provided, and certainly, other specific processing methods may also be group according to actual needs, which will not be limited in the embodiments of the present disclosure.

It is to be noted that, in the embodiments of the present disclosure, object tracking and determining object state may specifically be tracking and state judgment for various objects in the scene image. For example, object tracking and determining object state may involve the tracking and posture judgement of game props, which will not be limited in the embodiments of the present disclosure.

Specifically, in the embodiments of the present disclosure, in the image processing apparatus, before the invoking a parallel thread and performing a first object analysis processing on the plurality of groups of scene images to obtain first processing data, the following steps are further executed: the standard images corresponding to the game area at different viewpoints during a game preparation stage to obtain a plurality of frames of standard images is acquired, and each frame of standard image in the plurality of frames of standard images is a desktop image corresponding to the game area at a viewpoint; an image collection parameter corresponding to each frame of standard image in the plurality of frames of standard images is acquired; correspondingly, the invoking a parallel thread to perform a first object analysis processing on the plurality of groups of scene images to obtain first processing data includes the following step: the parallel thread is invoked, and the adaptation processing is performed with respect to each group of scene images in the plurality of groups of scene images by using the standard images at the same viewpoint in the plurality of frames of standard images and the image collection parameters corresponding to the standard images at the same viewpoint to obtain the corresponding adaptation result; the first processing data includes the adaptation result of each group of scene images in the plurality of groups of scene images.

It may be understood that, in the embodiments of the present disclosure, the adaptation processing of the scene image requires reference information, that is, the standard image and image collection parameters. Therefore, the image processing apparatus may acquire standard images corresponding to the game area at different viewpoints during a game preparation stage in advance. Here, the various viewpoints collected by the standard image need to correspond one-to-one with the various viewpoints collected by a plurality of groups of scene images. In addition, the image processing apparatus acquires the corresponding image acquisition parameters for each frame of standard image, the image collection parameters may be used to realize the determination of the mapping relationship between pixel points and spatial positions in the standard image.

It is to be noted that, in the embodiments of the present disclosure, the image processing apparatus invokes the parallel thread, and for each group of scene images in plurality of groups of scene images, the standard image at the same viewpoint and the image collection parameters of the standard image at the same viewpoint may be used to perform the adaption processing, for example, updating the mapping matrix, a specific area in the game area, etc., which will not be limited in the embodiments of the present disclosure.

It is to be noted that, in the embodiments of the present disclosure, in the process that the image processing apparatus invokes the parallel thread to perform the first object analysis processing on a plurality groups of scene images, for object tracking, determining object state, adaption processing, etc., each group of scene images is processed independently, and for information fusion, it may be realized by combining the information in the plurality of groups of scene images.

It is to be noted that, in the embodiments of the present disclosure, the second object analysis processing includes: object recognition, human hand recognition, and face recognition.

It may be understood that, in the embodiments of the present disclosure, the second object analysis processing mainly involves image recognition processing, which may include object recognition, human hand recognition, and face recognition. Specifically, in the board game scene, the object recognition involves game prop recognition and game currency recognition, etc. The specific information of the recognition may be the type of game props, the number and value of game currencies, etc. In addition, the above second object analysis processing will not be limited in embodiments of the present disclosure.

It is to be noted that, in the embodiments of the present disclosure, the image processing apparatus invokes the main thread to perform the second object analysis processing on a plurality of groups of scene images. Specifically, the image processing apparatus may invoke the main thread, and perform the second object analysis processing independently for each group of scene images in the plurality of groups of scene images, that is, the second processing data includes the GPU-intensive processing result of each group of scene images.

FIG. 2 illustrates a schematic diagram of an exemplary thread scheduling according to an embodiment of the present disclosure. As illustrated in FIG. 2, when the object is associated with the human body, the main thread is invoked, after that, when an analysis processing without association in timing sequence is executed, the main thread and the parallel thread are invoked at the same time to execute different object analysis processing procedures, and finally, the main thread is invoked to associate object and face.

It is to be noted that, in the embodiments of the present disclosure, the object analysis data includes the first association data, the second association data, the first processing data, and the second processing data obtained by the above image analysis processing.

In S103, the object analysis data is written into the object general-purpose data structure, and the object general-purpose data structure is provided with positions for supporting storage of various types of data related to the object analysis data.

In the embodiments of the present disclosure, the image processing apparatus may write the object analysis data into the object general-purpose data structure in the case where the image processing apparatus realizes the analysis of a plurality of groups of scene images and obtains the object analysis data.

It may be understood that, in the embodiments of the present disclosure, as described in S102, the object analysis data actually includes various types of data, such as data associated with the object and the human body, data associated with the object and the face, game currency recognition data, game prop recognition data, and object tracking data, with respect to a wide range of data, the image processing apparatus may write the analysis data of the same object into an object general object data structure, thereby realizing data output.

It is to be noted that in the embodiments of the present disclosure, a position supporting the storage of analysis data of one object is set in each object general-purpose data structure, in this way, the user may directly acquiring the analysis data of an object by directly reading the object general-purpose data structure, and when a certain type of data needs to be read from the object general-purpose data structure, the data may be quickly read directly from the position where the type of information is stored in the object general-purpose data structure.

FIG. 3 illustrates a schematic diagram of an exemplary object general-purpose data structure according to an embodiment of the present disclosure. As illustrated in FIG. 3, the object general-purpose data structure includes various types of information, such as channel number, frame number, detection frame, object category, tracking identification, quality information, and association information. For the analysis data of an object, each type of of data is set with the corresponding storage position. In addition, the object general-purpose data structure may also include additional address information, which is used to indicate the address of storing other additional information of the object. For example, the additional address information includes: instructions to store the color of the game props, the confidence degree of the color, the value of the game props, and the address of the confidence degree of the game prop value, these additional information may be acquired from the object analysis information.

Specifically, in the embodiments of the present disclosure, the image processing apparatus writes the object analysis data into the object general-purpose data structure, which includes as follows: data selection and/or data integration are performed on the object analysis data to obtain target analysis data; and the target analysis data is written into the object general-purpose data structure.

It is to be understood that, in the embodiments of the present disclosure, the image processing apparatus may firstly perform data selection and/or data integration on the object analysis data, for example, the apparatus selects the relevant data of the object in the specific area of the game area, integrates the data obtained from different viewpoints, so as to obtain the target analysis data, and then write the data, so as to ensure the effectiveness and comprehensiveness of the data.

It may be understood that, in the embodiments of the present disclosure, since the object analysis may involve each object in the scene image, the final object analysis data may cover the analysis data of each of the detected objects, and accordingly, the finally obtained object general-purpose data structure may be multiple, each of which may be used to store analysis data of one detected object, that is, the image processing apparatus may continuously output an array composed of a plurality of object general-purpose data structures.

The embodiments of the present disclosure provide an image processing method. The method includes the following steps: scene images corresponding to a game area at different viewpoints during a gaming stage are acquired to obtain a plurality of groups of scene images, and each group of scene images in the plurality of groups of scene images includes at least one frame of scene image corresponding to the game area at the same viewpoint; object analysis is performed on the plurality of groups of scene images to obtain object analysis data corresponding to the game area; and the object analysis data is written into an object general-purpose data structure, and the object general-purpose data structure is provided with positions for supporting storage of various types of data related to the object analysis data. In the image processing method provided by the embodiments of the present disclosure, a general object data structure that may cover the analysis data of all objects is set, and the analysis data of the object are stored directly in the form of the object general-purpose data structure, thereby reducing the memory occupied by data and improving the speed of data recording.

The embodiments of the present disclosure provides an image processing apparatus. FIG. 4 illustrates a schematic diagram of an image processing apparatus according to an embodiment of the present disclosure. As illustrated in FIG. 4, the image processing apparatus includes an acquisition module, an analysis module, and a writing module.

The acquisition module 401 is configured to acquire scene images corresponding to the game area at different viewpoints during a gaming stage to obtain a plurality of groups of scene images, and each group of scene images in the plurality of groups of scene images includes at least one frame of scene image corresponding to the game area at the same viewpoint.

The analysis module 402 is configured to perform object analysis on the plurality of groups of scene images to obtain object analysis data corresponding to the game area.

The writing module 403 is configured to write the object analysis data into an object general-purpose data structure, and the object general-purpose data structure is provided with positions for supporting storage of various types of data related to the object analysis data.

In an embodiment of the present disclosure, the the analysis module 402 is specifically configured to:
invoke a main thread to perform object detection on the plurality of groups of scene images and the association between an object and a human body to obtain first association data;
invoke a parallel thread to perform a first object analysis processing on the plurality of groups of scene images to obtain first processing data, and invoke the main thread at the same time to perform a second object analysis processing on the plurality of groups of scene images to obtain second processing data, the first object analysis processing and the second object analysis processing are not related in time sequence;
invoke the main thread to associate an object with a face for the plurality of groups of scene images according to the first association data, the first processing data, and the second processing data to obtain second association data; and
determine the first association data, the second association data, the first processing data, and the second processing data as the object analysis data.

In an embodiment of the present disclosure, the first object analysis includes object tracking, determining object state, adaptation processing, and information fusion.

In an embodiment of the present disclosure, the acquisition module 401 is further configured to: acquire standard images corresponding to the game area at different viewpoints during a game preparation stage to obtain a plurality of frames of standard images, and each frame of standard image in the plurality of frames of standard images is a desktop image corresponding to the game area at a viewpoint; acquire an image collection parameter corresponding to each frame of standard image in the plurality of frames of standard images;

The analysis module 402 is specifically configured to invoke the parallel thread to perform an adaptation processing on each group of scene images in the plurality of groups of scene images by using the standard images at the same viewpoint in the plurality of frames of standard images and the image collection parameters corresponding to the standard images at the same viewpoint to obtain the corresponding adaptation result; the first processing data includes the adaptation result of each group of scene images in the plurality of groups of scene images.

In an embodiment of the present disclosure, the second object analysis processing includes: object recognition, human hand recognition, and face recognition.

In an embodiment of the present disclosure, the storage module 403 is specifically configured to: perform data selection and/or data integration on the object analysis data to obtain target analysis data; and write the target analysis data into the object general-purpose data structure.

The embodiments of present disclosure provide an image processing apparatus. In the apparatus, scene images corresponding to the game area at different viewpoints during a gaming stage are acquired to obtain a plurality of groups of scene images, and each group of scene images in the plurality of groups of scene images includes at least one frame of scene image corresponding to the game area at the same viewpoint; object analysis is performed on the plurality of groups of scene images to obtain object analysis data corresponding to the game area; and the object analysis data is written into the object general-purpose data structure, and the object general-purpose data structure is provided with positions for supporting storage of various types of data related to the object analysis data. In the image processing apparatus provided by the embodiments of the present disclosure, a general object data structure that may cover the analysis data of all objects is set, and the analysis data of the object are stored directly in the form of the object general-purpose data structure, thereby reducing the memory occupied by data and improving the speed of data recording.

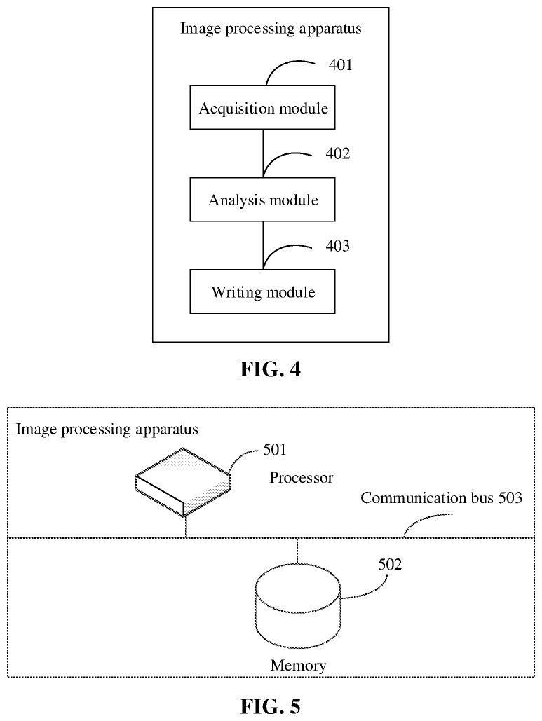

The embodiments of the present disclosure further provides an electronic device. FIG. 5 illustrates a schematic diagram of an electronic device according to an embodiment of the present disclosure. As illustrated in FIG. 5, the electronic device includes: a processor 501, a memory 502, and a communication bus 503.

The communication bus 503 is configured to implement connection and communication between the processor 501 and the memory 502.

The processor 501 is configured to execute one or more programs stored in the memory 502 to implement the above image processing method.

The present disclosure provides an image processing method, an apparatus, an electronic device and a storage medium. The method includes the following steps: scene images corresponding to a game area at different viewpoints during a gaming stage are acquired to obtain a plurality of groups of scene images, and each group of scene images in the plurality of groups of scene images includes at least one frame of scene image corresponding to the game area at the same viewpoint; object analysis is performed on the plurality of groups of scene images to obtain object analysis data corresponding to the game area; and the object analysis data is written into an object general-purpose data structure, and the object general-purpose data structure is provided with positions for supporting storage of various types of data related to the object analysis data. In the technical solution provided by the embodiments of the present disclosure, a general-purpose object data structure that may cover the analysis data of all objects is set, and the analysis data of the object are stored directly in the form of the object general-purpose data structure, thereby reducing the memory occupied by data and improving the speed of data recording.

The embodiments of the present disclosure provide a computer-readable storage medium, the computer-readable storage medium stores one or more programs, and the one or more programs may be executed by one or more processors to implement the above image processing method. The computer-readable storage medium may be a volatile memory (volatile memory), such as a random-access memory (RAM); or a non-volatile memory (non-volatile memory), such as a read-only memory (ROM), flash memory (flash memory), hard disk drive (HDD) or solid-state drive (SSD); the computer-readable storage medium may also be a respective device including one or any combination of the above memories, such as a mobile phone, a computer, a tablet device, a personal digital assistant, etc.

A person skilled in the art should understand that the embodiments of the present disclosure may be provided as a method, a system, or a computer program product. Therefore, the present disclosure may adopt the form of a hardware embodiment, a software embodiment, or an embodiment combining software and hardware. Moreover, the present disclosure may take the form of a computer program product implemented on one or more computer-usable storage medium (including but not limited to magnetic disk memory, optical memory, etc.) including computer-usable program codes.

The present disclosure is described with reference to flowcharts and/or block diagrams of methods, devices (systems), and computer program products according to the embodiments of the present disclosure. It is to be understood that each process and/or block in the flowchart and/or block diagram, and the combination of processes and/or blocks in the flowchart and/or block diagram may be implemented by computer program instructions. These computer program instructions may be provided to the processor of a general-purpose computer, a special-purpose computer, an embedded processor, or other programmable signal processing devices to generate a machine, so that the instructions executed by the processor of the computer or other programmable signal processing devices generate an apparatus for implementing the functions specified in one or more processes in the flowchart and/or one or more blocks in the block diagram.

These computer program instructions may also be stored in a computer-readable memory that may direct a computer or other programmable signal processing devices to operate in a specific manner, so that the instructions stored in the computer-readable memory produce manufactured goods including the instruction apparatus. The instruction apparatus implements the functions specified in one or more processes in the flowchart and/or one or more blocks in the block diagram.

These computer program instructions may also be loaded on a computer or other programmable signal processing devices, so that a series of operation steps are executed on the computer or other programmable devices to produce computer-implemented processing, thereby the instructions executed on the computer or other programmable devices provide steps for implementing the functions specified in one or more processes in the flowchart and/or one or more blocks in the block diagram.

The above are only preferred embodiments of the present disclosure, and are not used to limit the protection scope of the present disclosure.

1. An image processing method, comprising:
acquiring scene images corresponding to a game area at different viewpoints during a gaming stage to obtain a plurality of groups of scene images; wherein each group of scene images in the plurality of groups of scene images comprises at least one frame of scene image corresponding to the game area at a same viewpoint;
performing object analysis on the plurality of groups of scene images to obtain object analysis data corresponding to the game area; and
writing the object analysis data into an object general-purpose data structure, wherein the object general-purpose data structure is provided with positions for supporting storage of various types of data related to the object analysis data.

2. The method of claim 1, wherein performing object analysis on the plurality of groups of scene images to obtain object analysis data corresponding to the game area comprises:
invoking a main thread to perform object detection on the plurality of groups of scene images, and to perform association between an object and a human body to obtain first association data;
invoking a parallel thread to perform a first object analysis processing on the plurality of groups of scene images to obtain first processing data, and invoking the main thread at a same time to perform a second object analysis processing on the plurality of groups of scene images to obtain second processing data, wherein the first object analysis processing and the second object analysis processing are not associated in time sequence;
invoking the main thread to associate an object with a face for the plurality of groups of scene images according to the first association data, the first processing data, and the second processing data to obtain second association data; and
determining the first association data, the second association data, the first processing data, and the second processing data as the object analysis data.

3. The method of claim 2, wherein the first object analysis processing comprises: object tracking, determining object state, adaptation processing, and information fusion.

4. The method of claim 3, wherein before invoking the parallel thread to perform the first object analysis processing on the plurality of groups of scene images to obtain the first processing data, the method further comprises:
acquiring standard images corresponding to the game area at different viewpoints during a game preparation stage to obtain a plurality of frames of standard images, wherein each frame of standard image in the plurality of frames of standard images is a desktop image corresponding to the game area at a viewpoint;
acquiring an image collection parameter corresponding to each frame of standard image in the plurality of frames of standard images;
correspondingly, invoking the parallel thread to perform the first object analysis processing on the plurality of groups of scene images to obtain the first processing data comprises:
invoking the parallel thread to perform an adaptation processing on each group of scene images in the plurality of groups of scene images by using standard images at a same viewpoint in the plurality of frames of standard images and the image collection parameters corresponding to the standard images at the same viewpoint to obtain a corresponding adaptation result,
wherein the first processing data comprises the adaptation result of each group of scene images in the plurality of groups of scene images.

5. The method of claim 2, wherein the second object analysis processing comprises: object recognition, human hand recognition, and face recognition.

6. The method of claim 1, wherein writing the object analysis data into the object general-purpose data structure comprises:
performing data selection and/or data integration on the object analysis data to obtain target analysis data; and
writing the target analysis data into the object general-purpose data structure.

7. An image processing apparatus, comprising:
a memory for storing instructions; and
a processor configured to execute the instructions to:
acquire scene images corresponding to a game area at different viewpoints during a gaming stage to obtain a plurality of groups of scene images, wherein each group of scene images in the plurality of groups of scene images comprises at least one frame of scene image corresponding to the game area at a same viewpoint;
perform object analysis on the plurality of groups of scene images to obtain object analysis data corresponding to the game area; and
write the object analysis data into an object general-purpose data structure, wherein the object general-purpose data structure is provided with positions for supporting storage of various types of data related to the object analysis data.

8. The apparatus of claim 7, wherein
the processor is configured to execute the instructions to:
invoke a main thread to perform object detection on the plurality of groups of scene images, and to perform association between an object and a human body to obtain first association data;
invoke a parallel thread to perform a first object analysis processing on the plurality of groups of scene images to obtain first processing data, and invoke the main thread at a same time to perform a second object analysis processing on the plurality of groups of scene images to obtain second processing data, wherein the first object analysis processing and the second object analysis processing are not related in time sequence;
invoke the main thread to associate an object with a face for the plurality of groups of scene images according to the first association data, the first processing data, and the second processing data to obtain second association data; and
determine the first association data, the second association data, the first processing data, and the second processing data as the object analysis data.

9. The apparatus of claim 8, wherein the first object analysis processing comprises: object tracking, determining object state, adaptation processing, and information fusion.

10. The apparatus of claim 9, wherein the processor is configured to execute the instructions to: before invoking the parallel thread to perform the first object analysis processing on the plurality of groups of scene images to obtain the first processing data:
acquire standard images corresponding to the game area at different viewpoints during a game preparation stage to obtain a plurality of frames of standard images, wherein each frame of standard image in the plurality of frames of standard images is a desktop image corresponding to the game area at a viewpoint;
acquire an image collection parameter corresponding to each frame of standard image in the plurality of frames of standard images;
correspondingly, the processor is configured to execute the instructions to:
invoke the parallel thread to perform an adaptation processing on each group of scene images in the plurality of groups of scene images by using standard images at a same viewpoint in the plurality of frames of standard images and the image collection parameters corresponding to the standard images at the same viewpoint to obtain a corresponding adaptation result,
wherein the first processing data comprises the adaptation result of each group of scene images in the plurality of groups of scene images.

11. The apparatus of claim 8, wherein the second object analysis processing comprises: object recognition, human hand recognition, and face recognition.

12. The apparatus of claim 7, wherein the processor is configured to execute the instructions to:
perform data selection and/or data integration on the object analysis data to obtain target analysis data; and
write the target analysis data into the object general-purpose data structure.

13. A computer-readable storage medium having stored thereon one or more programs that when executed by one or more processors to implement an image processing method, the method comprising:
acquiring scene images corresponding to a game area at different viewpoints during a gaming stage to obtain a plurality of groups of scene images; wherein each group of scene images in the plurality of groups of scene images comprises at least one frame of scene image corresponding to the game area at a same viewpoint;
performing object analysis on the plurality of groups of scene images to obtain object analysis data corresponding to the game area; and
writing the object analysis data into an object general-purpose data structure, wherein the object general-purpose data structure is provided with positions for supporting storage of various types of data related to the object analysis data.

14. The computer-readable storage medium of claim 13, wherein performing object analysis on the plurality of groups of scene images to obtain object analysis data corresponding to the game area comprises:
invoking a main thread to perform object detection on the plurality of groups of scene images, and to perform association between an object and a human body to obtain first association data;
invoking a parallel thread to perform a first object analysis processing on the plurality of groups of scene images to obtain first processing data, and invoking the main thread at a same time to perform a second object analysis processing on the plurality of groups of scene images to obtain second processing data, wherein the first object analysis processing and the second object analysis processing are not associated in time sequence;
invoking the main thread to associate an object with a face for the plurality of groups of scene images according to the first association data, the first processing data, and the second processing data to obtain second association data; and
determining the first association data, the second association data, the first processing data, and the second processing data as the object analysis data.

15. The computer-readable storage medium of claim 14, wherein the first object analysis processing comprises: object tracking, determining object state, adaptation processing, and information fusion.

16. The computer-readable storage medium of claim 15, wherein before invoking the parallel thread to perform the first object analysis processing on the plurality of groups of scene images to obtain the first processing data, the method further comprises:
acquiring standard images corresponding to the game area at different viewpoints during a game preparation stage to obtain a plurality of frames of standard images, wherein each frame of standard image in the plurality of frames of standard images is a desktop image corresponding to the game area at a viewpoint;
acquiring an image collection parameter corresponding to each frame of standard image in the plurality of frames of standard images;
correspondingly, invoking the parallel thread to perform the first object analysis processing on the plurality of groups of scene images to obtain the first processing data comprises:
invoking the parallel thread to perform an adaptation processing on each group of scene images in the plurality of groups of scene images by using standard images at a same viewpoint in the plurality of frames of standard images and the image collection parameters corresponding to the standard images at the same viewpoint to obtain a corresponding adaptation result,
wherein the first processing data comprises the adaptation result of each group of scene images in the plurality of groups of scene images.

17. The computer-readable storage medium of claim 14, wherein the second object analysis processing comprises: object recognition, human hand recognition, and face recognition.

18. The computer-readable storage medium of claim 13, wherein writing the object analysis data into the object general-purpose data structure comprises:
performing data selection and/or data integration on the object analysis data to obtain target analysis data; and
writing the target analysis data into the object general-purpose data structure.
